(19) United States
(12) Patent Application Publication
(10) Pub. No.: US 2025/0367956 A1
(43) Pub. Date: Dec. 4, 2025

(54) LIQUID EJECTION APPARATUS AND LIQUID EJECTION APPARATUS CONTROL METHOD

(71) Applicant: CANON KABUSHIKI KAISHA, Tokyo (JP)

(72) Inventors: TAKAHIRO KIUCHI, Tokyo (JP); YUMI SUZUKI, Tokyo (JP); YUSUKE IINO, Kanagawa (JP); SHIMPEI SHINOHARA, Kanagawa (JP); KEN TAKENAGA, Kanagawa (JP); KATSUAKI SUKEGAWA, Kanagawa (JP); NORIYUKI SUGIYAMA, Kanagawa (JP); MASAKAZU INADA, Kanagawa (JP); HIROKAZU YOSHIKAWA, Kanagawa (JP)

(21) Appl. No.: 19/219,912

(22) Filed: May 27, 2025

(30) Foreign Application Priority Data
May 31, 2024 (JP) 2024-089183

(51) Int. Cl. B41J 29/393; B41J 3/44; B41J 3/60; B41J 13/08; B41J 13/32; B41J 25/00; H02P 5/00; H04N 1/00

(52) U.S. Cl. CPC B41J 29/393; B41J 3/44; B41J 3/60; B41J 13/08; B41J 13/32; B41J 25/001; H02P 5/00; H04N 1/00798; H04N 1/00896; H04N 2201/0081

(57) ABSTRACT

A liquid ejection apparatus and a liquid ejection apparatus control method capable of keeping the power consumption of the liquid ejection apparatus within an appropriate range. To this end, control is performed such that a current upper limit value for a conveyor motor is switched in a state where operations of other power consumption units are restricted.

### BACKGROUND

Field of the Technology

The present disclosure relates to a liquid ejection apparatus and a liquid ejection apparatus control method.

### DESCRIPTION OF THE RELATED ART

In order to avoid an increase in the apparatus size of a liquid ejection apparatus or from the viewpoint of environmental considerations, there is a demand to reduce the power supply capacity of the entire liquid ejection apparatus.

Japanese Patent Laid-Open No. 2014-105107 discloses that a current upper limit value for a motor is controlled based on a driving voltage for driving the motor.

However, the configuration according to Japanese Patent Laid-Open No. 2014-105107 can regulate the upper limit of the power consumption of a single motor, but has difficulty saving the power consumption of an entire apparatus equipped with multiple power consumption units. In other words, in order to deal with a case where multiple power consumption units concurrently consume power, the system has to be controlled with the power consumption of the entire system taken into consideration.

### SUMMARY

Therefore, the present disclosure provides a liquid ejection apparatus and a liquid ejection apparatus control method capable of keeping a power consumption of the liquid ejection apparatus within an appropriate range.

To this end, a liquid ejection apparatus according to some embodiments includes: an ejection unit configured to eject a liquid; a motor in which a current value varies depending on a load; a power consumption unit different from the motor; a power source configured to supply power to the motor and the power consumption unit; and a controller unit configured to control the motor and the power consumption unit. The controller unit is capable of shifting between a first mode of controlling the motor and the power consumption unit in a state where an upper limit value of a current suppliable to the motor is set to a first upper limit value, and a second mode of controlling the motor and the power consumption unit in a state where the upper limit value of the current suppliable to the motor is set to a second upper limit value that is greater than the first upper limit value and a power consumption of the power consumption unit is kept lower than in the first mode.

According to the present disclosure, it is possible to provide a technique for a liquid ejection apparatus including multiple power consumption units to keep a power consumption within an appropriate range.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are perspective views illustrating a liquid ejection apparatus.

FIG. 2 is a block diagram illustrating a controller unit of a print system.

FIG. 3 is a cross-sectional view of the liquid ejection apparatus.

FIGS. 4A to 4D are cross-sectional views illustrating a conveyance path of a print medium in the liquid ejection apparatus,

FIG. 5 is a perspective view illustrating a recovery unit in the liquid ejection apparatus,

FIG. 6 is a graph presenting a relationship between a current and a torque in a DC motor,

FIG. 7 is a graph presenting power consumptions and a total power consumption.

FIG. 8 is a flowchart presenting pre-processing for back-side printing.

FIG. 9 is a view illustrating a print head and a cap in the liquid ejection apparatus.

FIG. 10 is a flowchart presenting uncapping processing.

### DESCRIPTION OF THE EMBODIMENTS

Hereinafter, various exemplary embodiments, features, and aspects of the present disclosure will be described with reference to the drawings.

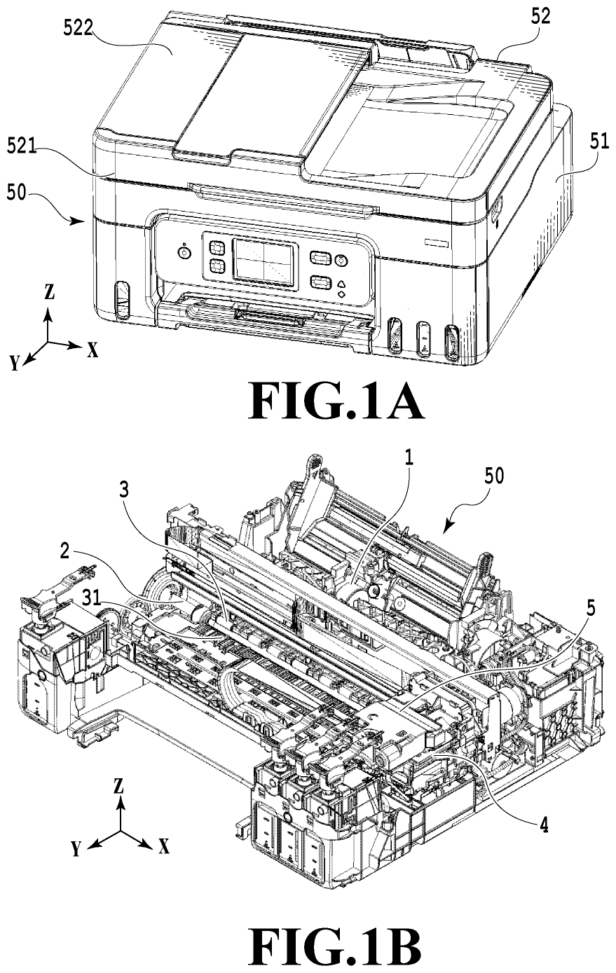

FIG. 1A is a perspective view illustrating an external appearance of a liquid ejection apparatus 50 to which the present disclosure is applicable, and FIG. 1B is a perspective view illustrating an interior of the liquid ejection apparatus 50. The liquid ejection apparatus 50 includes a print unit 51 configured to perform printing on a medium being conveyed and a reader unit 52 configured to read a read-target medium. The reader unit 52 includes a flatbed scanner unit 521 with a fixed document reading method of fixing a read-target medium and reading the fixed medium, and an auto document feeder (ADF) scanner unit 522 with a document feeding-reading method of reading a read-target medium while feeding the medium. In sum, the liquid ejection apparatus 50 includes two types of document readers.

The liquid ejection apparatus 50 includes a paper feed roller 1 to feed a print medium, a conveyor roller 2 to convey the print medium, and pinch rollers 3 to be driven by the conveyor roller 2. The print medium is conveyed onto a platen 31 while being nipped between the conveyor roller 2 and the pinch rollers 3, and liquid is ejected by a print head 4 onto the print medium to print an image thereon. The print head 4 is held by a carriage 5 and performs printing by ejecting the liquid to each of desired positions in a width direction (X direction) of the print medium while reciprocating in the X direction.

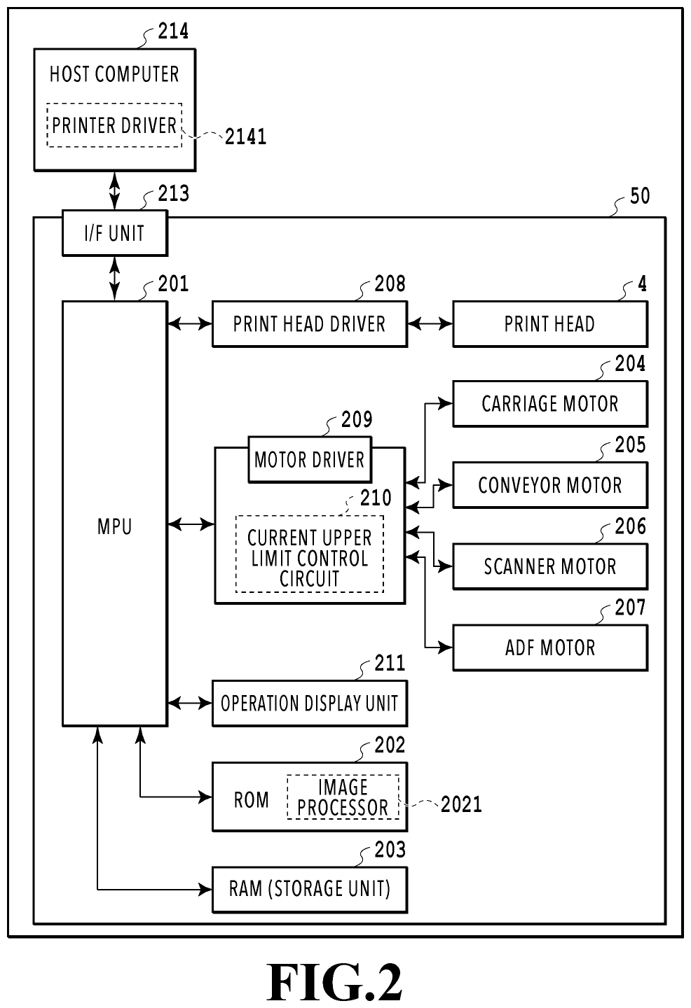

FIG. 2 is a block diagram of a controller unit of a print system in which a host computer 214 and the liquid ejection apparatus 50 are coupled with each other. The liquid ejection apparatus 50 includes a micro processing unit (MPU) 201 as well as a print head driver 208, a motor driver 209, an operation display unit 211, a read only memory (ROM) 202, and a random-access memory (RAM) 203, which are coupled with the MPU 201. The MPU 201 controls the entire liquid ejection apparatus 50 such as operations and data processing in all the units. The ROM 202 stores programs to be executed by the MPU 201 and various data. The RAM 203 temporarily stores data to be processed by the MPU 201 and data received from the host computer 214. The print head driver 208 controls the print head 4.

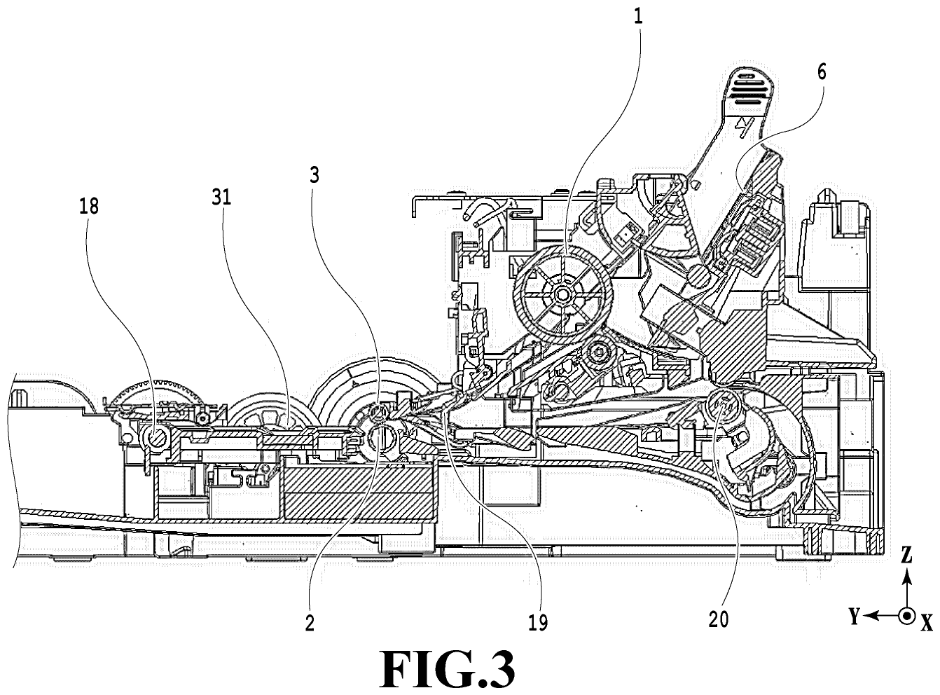

The motor driver 209 controls a carriage motor 204 capable of driving the carriage 5, a conveyor motor 205, a scanner motor 206 to drive the flatbed scanner unit 521, and an ADF motor 207 to drive the ADF scanner unit 522. The carriage motor 204, the conveyor motor 205, the scanner motor 206, and the ADF motor 207 can be supplied with power from a common power source. The motor driver 209 includes a current upper limit control circuit 210 to define an upper limit value of currents to be supplied to the motors 204 to 207 coupled with the motor driver 209. The current upper limit control circuit 210 is capable of defining multiple levels of current upper limit values, and switching the current upper limit value among these multiple set values based on an instruction from the MPU 201. The conveyor motor 205 is a direct current (DC) motor to drive the conveyor roller 2, a relay roller 20, and a discharge roller 18 (see FIG. 3 for these rollers). Each of the motors 204 to 207 coupled with the motor driver 209 is a motor whose current value variers passively according to a load torque. Although the conveyor motor 205 is described as the DC motor in the present embodiment, the conveyor motor 205 may be an alternating current (AC) motor.

The host computer 214 is provided with a printer driver 2141 configured to, in a case where a user issues an instruction to execute a printing operation, collect and organize print information on a print image, print image qualities, and so on, and communicating the print information to the liquid ejection apparatus 50. The MPU 201 exchanges the print image and so on with a host computer 214 via an interface (I/F) unit 213.

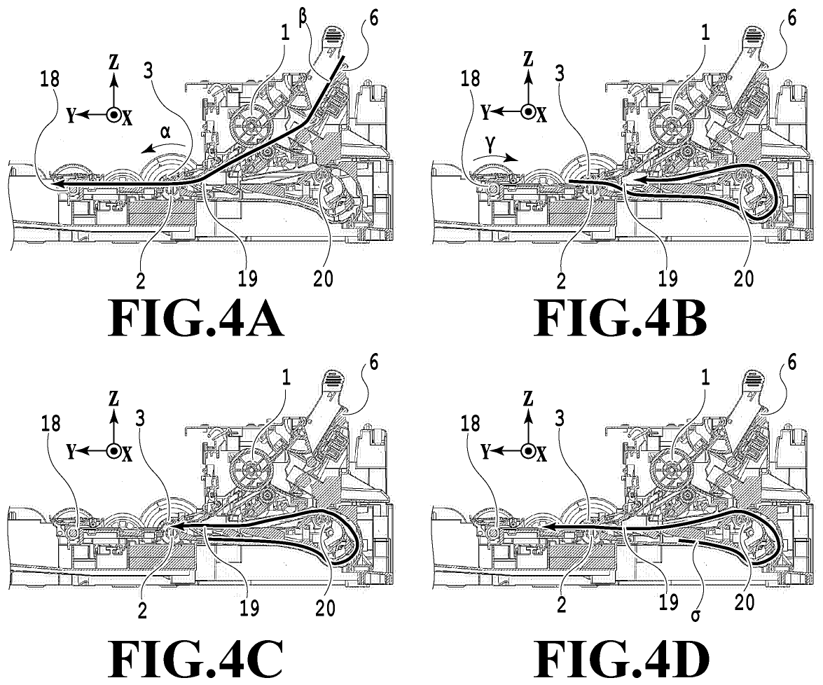

FIG. 3 is a cross-sectional view of the liquid ejection apparatus 50, and FIGS. 4A to 4D are cross-sectional views illustrating a print medium conveyor unit (conveyance path) in the liquid ejection apparatus 50. The paper feed roller 1, the conveyor roller 2, the discharge roller 18, and the relay roller 20 are driven by the common driving source, that is, the conveyor motor 205. Among print media stacked on a paper feed tray 6, an uppermost print medium is fed by the paper feed roller 1 into the apparatus, is conveyed by the conveyor roller 2, is subjected to printing at a position on the platen 31, and then is delivered in a Y direction by the discharge roller 18. A paper sensor 19 is installed at a position between the paper feed roller 1 and the conveyor roller 2. In a case where the paper sensor 19 fails to detect a paper sheet even though the paper feed roller 1 is rotated, the MPU 201 issues a notification of a jam error or the like.

FIGS. 4A to 4D illustrate a case of so-called double-sided printing of printing images on both the front and back sides of a print medium. In executing a printing operation, the MPU 201 causes the conveyor roller (main conveyor roller) 2 and the pinch rollers 3 to nip a print medium in between, and rotates the conveyor roller 2 in a forward direction (arrow α direction in FIG. 4A), thereby passing the print medium through a path indicated by an arrow β in FIG. 4A. The MPU 201 causes the print head 4 to perform printing according to print data while moving the carriage 5, thereby performing the printing on the front side of the print medium. The image is printed on the front side of the print medium sequentially by alternate repetitions of the conveyance of the print medium in the conveyance direction by the conveyor motor 205 and the printing operation by the print head 4. Upon completion of the printing on the front side of the print medium, the MPU 201 releases the print medium from the nip between the conveyor roller 2 and the pinch rollers 3. In the case of single-sided printing, the MPU 201 rotates the discharge roller 18 in a forward direction to deliver the print medium to outside of the apparatus.

On the other hand, in the case of double-sided printing, the MPU 201 rotates the discharge roller 18 in a reverse direction (arrow γ direction in FIG. 4B) upon completion of the printing on the front side. Then, the MPU 201 conveys the print medium in a direction reverse (−Y direction) to the conveyance direction for the front-side printing and causes the conveyor roller 2 and the pinch rollers 3 to nip the print medium in between again. After the print medium is nipped, the MPU 201 further rotates the conveyor roller 2 in a reverse direction (direction reverse to the arrow α direction in FIG. 4A) to convey the print medium to a path different from the path for the front-side printing, sets a trailing end of the print medium during the front-side printing as a leading end for the back-side printing, and causes this leading edge to reach the relay roller 20. Irrespective of the rotation direction of the conveyor roller 2, the relay roller 20 rotates so as to convey the print medium in the Y direction, although the relay roller 20 shares the driving source with the conveyor roller 2. Before the leading edge of the print medium reaches the paper sensor 19, the MPU 201 stops the conveyor motor 205 and thereby stops the rotations of the conveyor roller 2 and the relay roller 20 (see FIG. 4B).

Thereafter, the MPU 201 rotates the relay roller 20 in the forward direction while rotating the conveyor roller 2 in the reverse direction, passes the leading edge of the print medium through a detection position of the paper sensor 19, and brings the leading edge into contact with the conveyor roller 2 (see FIG. 4C). A skew of the print medium is corrected with the leading edge of the print medium brought into contact with the conveyor roller 2. After that, the MPU 201 switches the rotation of the conveyor roller 2 to the forward direction. Then, in the same manner as in the front-side printing, the back-side printing is performed by alternate repetitions of the conveyance of the print medium in the conveyance direction by the conveyor motor 205 and the printing operation by the print head 4. Through the aforementioned series of operations, it is possible to complete double-sided printing on a print medium with a single paper feed operation from the paper feed roller 1 (see FIG. 4D).

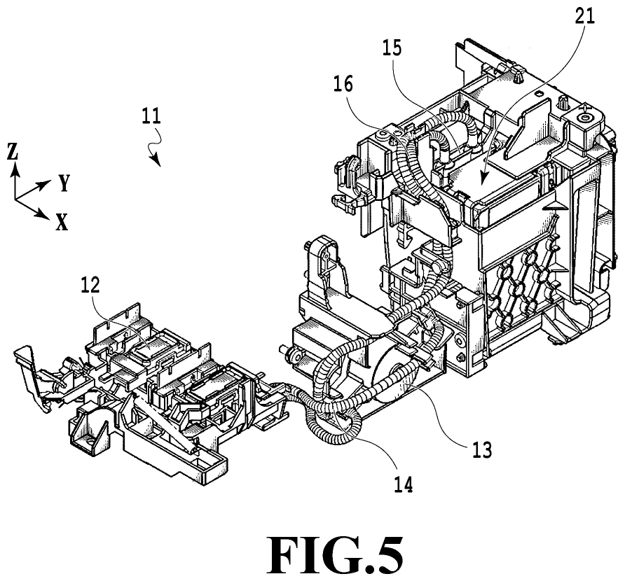

FIG. 5 is a perspective view illustrating a recovery unit 11 in the liquid ejection apparatus 50. The recovery unit 11 includes a cap 12 to cap an ink ejection orifice surface (not illustrated) of the print head 4, a suction pump 13 to suck the ink inside the cap 12, and a suction tube 14 coupling the cap 12 and the suction pump 13 with each other. Moreover, the recovery unit 11 includes a waste ink tank 21 to store waste ink sucked by the suction pump 13, a discharge unit 15 to discharge the waste ink into the waste ink tank 21, and a discharge tube 16 coupling the suction pump 13 and the discharge unit 15 with each other. Using the carriage motor 204 as a driving source, the recovery unit 11 moves the cap 12 up and down and brings the cap 12 into contact with the print head 4, thereby periodically performing recovery processing on the print head 4. This processing recovers an ejection state of the print head 4 by removing the ink remaining in and around the ejection orifices of the print head 4.

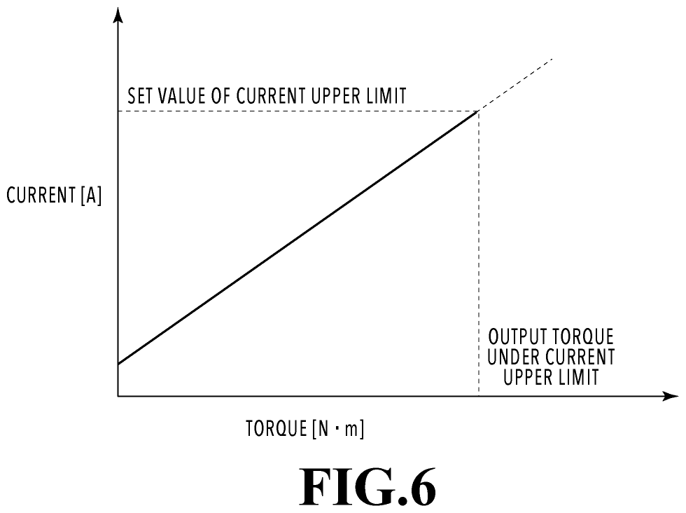

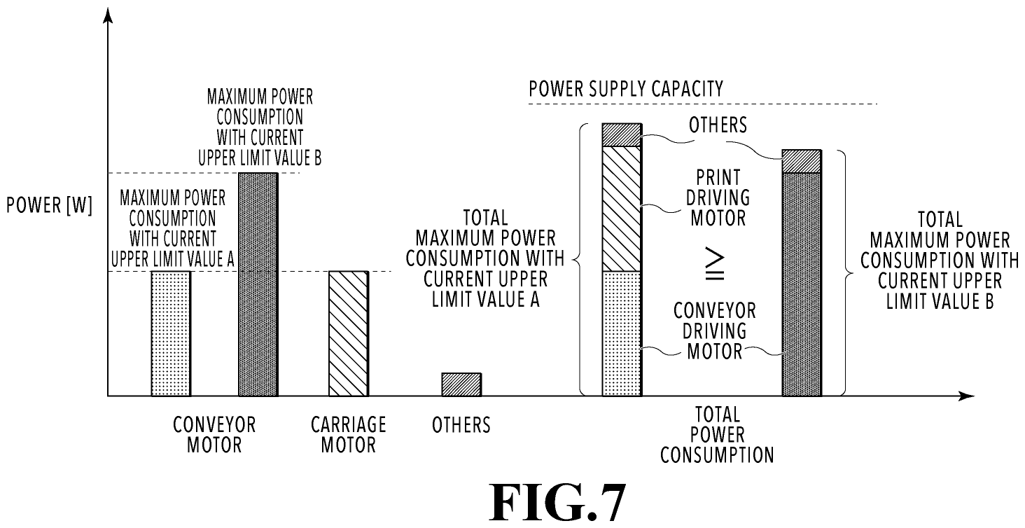

FIG. 6 is a graph presenting a relationship between a current [A] and a torque [N·m] in the DC motor, and FIG. 7 is a graph presenting power consumptions of the conveyor motor 205, the carriage motor 204, and the other power consumption units, and a total power consumption. In order to satisfy low costs and high stopping accuracy, the liquid ejection apparatus 50 employs the DC motors as the carriage motor 204, the conveyor motor 205, the scanner motor 206, and the ADF motor 207. The DC motor has a linear relationship between the torque and the current value as presented in FIG. 6. In other words, the higher the torque generated, the greater the current value. Since the power consumption of a motor is proportional to the square of a current flowing through the motor, the motor consumes a larger amount of power as a larger current flows through the motor. Once this power consumption value exceeds the power supply capacity of the power source, the power source causes an instantaneous interruption.

To address this undesirable situation, the motor driver 209 includes the current upper limit control circuit 210 (see FIG. 2). The motor driver 209 sets an upper limit value on the currents to be supplied to the motors, thereby restricting the output torques instead of preventing a power shortage from causing an instantaneous interruption.

The power control for a single motor (power consumption unit) can be achieved by setting an upper limit value on a current to be supplied to the motor. However, the power control for multiple power consumption units as in the present embodiment becomes more complicated.

As described above, the motor driver 209 in the present embodiment includes the current upper limit control circuit 210 and sets a current upper limit value for the conveyor motor 205 and the carriage motor 204. Here, the current upper limit value for each motor is referred to as a current upper limit value A. The conveyor motor 205 and the carriage motor 204 are driven concurrently in parallel in some cases. For this reason, a design value of the power supply capacity is set such that a total sum of power consumptions of the conveyor motor 205 and the carriage motor 204 receiving the currents at the current upper limit value A and power consumptions of the other power consumption units will be kept within the power supply capacity.

However, in other some cases, the conveyor motor 205 and the carriage motor 204 do not operate concurrently. For example, in the case where the conveyor motor 205 is driven while the carriage motor 204 is not driven, the total sum of the power consumptions of the conveyor motor 205 and the other power consumption units leaves a sufficient margin with respect to the power supply capacity of the power source, even if the current at the current upper limit value A flows into the conveyor motor 205. In other words, a current exceeding the current upper limit value A can be supplied to the conveyor motor 205 (see the total power consumption in FIG. 7).

Accordingly, in the present embodiment, for the conveyor motor 205, the current upper limit value A and a current upper limit value B that is greater than the current upper limit value A are set. With the power consumptions in the power consumption units other than the conveyor motor 205 taken into account, the current upper limit value is switched between the current upper limit value A and the current upper limit value B according to a usage state of the conveyor motor 205.

Hereinafter, the driving control of the conveyor motor 205 for the double-sided printing will be described by referring to FIGS. 4A to 4D again.

The liquid ejection apparatus 50 performs the conveyance for the double-sided printing through the operations as in FIGS. 4A to 4D as described above. The skew correction operation is performed by bringing the leading edge of the print medium, which has been turned upside down, into contact with the conveyor roller 2 as illustrated in FIG. 4C. In the skew correction, the relay roller 20 operates so as to further convey the print medium in the conveyance direction with the leading edge put in contact with the conveyor roller 2. For this reason, the contact area between the print medium and the conveyance path on a side downstream of the relay roller 20 in the conveyance direction increases, which also increases the resistance (friction) acting on the print medium. In this state, the rotation of the relay roller 20 uses a high torque. Accordingly, the conveyor motor 205 uses a high torque to simultaneously drive both the conveyor roller 2 and the relay roller 20. If the conveyor motor 205 cannot generate a sufficient torque in this operation, the skew correction of the print medium will be insufficient, which results in the back-side printing in the skewed state.

In the operation of printing on the front side of the print medium, the skew correction of the print medium is also performed, but the torque used for this skew correction is lower than that for the skew correction for the back side. Therefore, description herein will be given of the skew correction for back-side printing using torque control because the conveyor motor 205 uses a higher torque for the skew correction.

In execution of the skew correction operation (the operation illustrated in FIG. 4C), the current upper limit value for the conveyor motor 205 is increased (from the current upper limit value A to the current upper limit value B) while the power consumptions of the power consumption units other than the conveyor motor 205 are restricted. After the skew correction operation is completed, the current upper limit value is restored to the previous value (from the current upper limit value B to the current upper limit value A). In the operation illustrated in FIG. 4D and subsequent operations, the other power consumption units with their power consumptions having been restricted are released from the restriction and resume performing the operations concurrent with the conveyor motor 205.

The above power consumption units other than the conveyor motor 205 include the carriage motor 204, the scanner motor 206, and the ADF motor 207, and these motors are also stopped. Moreover, not only the motors, but also the other power consumption units, for example, the print head (predetermined mechanism) 4, are also stopped from being driven. In other words, the ejection operation of the print head 4 is also interrupted during the skew correction operation.

The above description is given by using the example in which the other power consumption units are stopped while the upper limit value for the conveyor motor 205 is being increased, but the control is not limited to the case where the other units are stopped. The control is intended to keep the power consumption peak of the power consumption units coupled with the same power source from exceeding a certain value. For this reason, for example, in a case where the power supply capacity still has a margin even if the current upper limit value for the conveyor motor 205 is set to the high value in the skew correction operation, the other power consumption units may be driven in a limited manner within that margin.

For example, the carriage motor 204 to be driven for preliminary ejection (preparatory ejection) may be operated with the power consumption kept low under the control of the MPU 201 such that a voltage at a certain value or higher will not be applied to the carriage motor 204. During the skew correction operation, the current upper limit value for the other motors including the carriage motor 204 is also set to the high level. However, by putting an upper limit value on a voltage to be applied to each of the motors, the MPU 201 can operate the liquid ejection apparatus 50 within the predetermined power supply capacity while controlling the power consumptions of all the motors within the margin. For example, by putting the upper limits on the voltage of the carriage motor 204 and the number of droplets ejected by the print head 4 so as to control their power consumptions within the margin, the MPU 201 enables the print head 4 to perform the preliminary ejection during the skew correction operation.

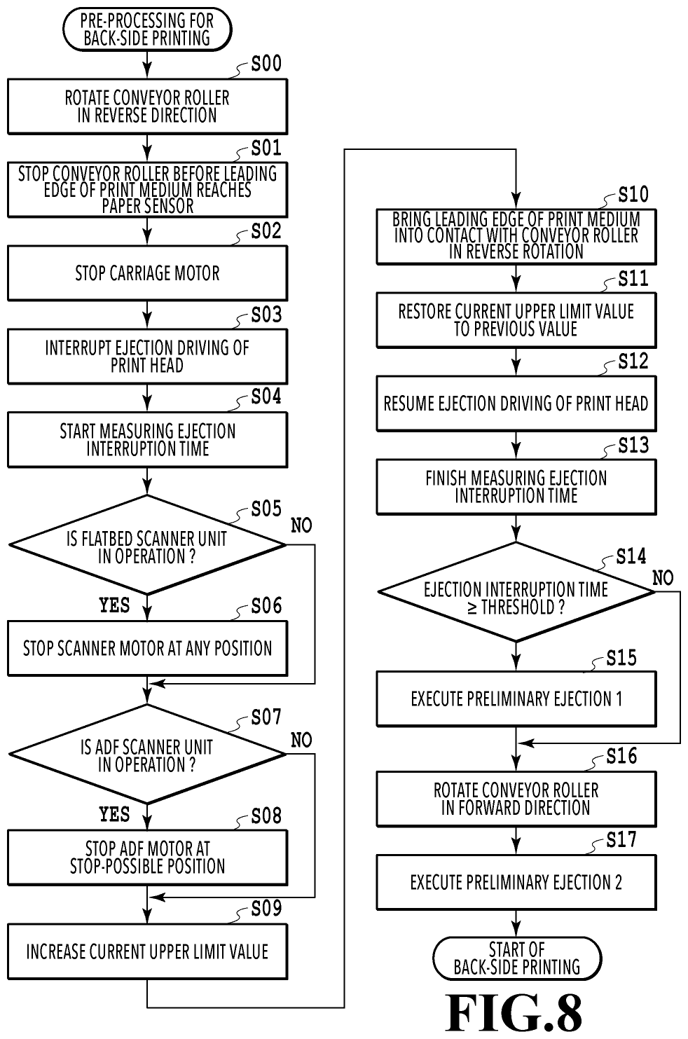

FIG. 8 is a flowchart presenting pre-processing for back-side printing in the present embodiment. This processing is for describing back-side printing processing, which is part of a double-sided printing mode, and is started at a time point at which a print medium, having been turned upside down, is nipped by a nip portion of the conveyor roller after the completion of the front-side printing. Hereinafter, the pre-processing for back-side printing in the present embodiment will be described by using the flowchart of FIG. 8. A series of processes presented in FIG. 8 is performed by the MPU 201 in the liquid ejection apparatus 50 loading program codes stored in the ROM 202 into the RAM 203 and executing the loaded program codes. Instead, some or all of functions in steps of FIG. 8 may be implemented by hardware such as an application-specific integrated circuit (ASIC) or electronic circuit. In description of each process, sign “S” indicates a step in this flowchart.

At the start of the pre-processing for back-side printing, the MPU 201 switches the rotation direction of the conveyor roller 2 from the forward rotation and rotates the conveyor roller 2 in the reverse direction. In S01, the MPU 201 stops the conveyor motor 205 at a position where the leading edge of the print medium reaches immediately before the upstream side of the paper sensor 19 (see FIG. 4B). The MPU 201 stops the carriage motor 204 in S02 and interrupts the ejection driving of the print head 4 performing the preliminary ejection in S03. The MPU 201 starts measuring an ink ejection interruption time in S04. Next, in S05, the MPU 201 determines whether the flatbed scanner unit 521 is in operation. The flatbed scanner unit 521 is in operation in some cases, for example, if a print job and a read job to use the flatbed scanner are successively inputted. If the flatbed scanner unit 521 is in operation (S05: Yes), the MPU 201 advances to S06 and stops the scanner motor 206 at any position. If the flatbed scanner unit 521 is out of operation (S05: No), the MPU 201 advances to S07 directly.

In S07, the MPU 201 determines whether the ADF scanner unit 522 is in operation. The ADF scanner unit 522 is in operation in some cases, for example, if a print job and a read job to use the ADF are successively inputted. If the ADF scanner unit 522 is in operation (S07: Yes), the MPU 201 advances to S08 and stops the ADF motor 207 at a stop-possible position. If the ADF scanner unit 522 is out of operation (S07: No), the MPU 201 advances to S09 directly. Either S06 or S08 is executed under exclusive control. Specifically, the flatbed scanner unit 521 and the ADF scanner unit 522 are never driven simultaneously, and only one of the units 521 and 522 is exclusively driven for scanner driving.

In S09, the MPU 201 increases the current upper limit value so as to enable the conveyor motor 205 to produce a necessary torque (switch from the current upper limit value A to the current upper limit value B). In S10, the MPU 201 causes the conveyor motor 205 to drive the conveyor roller 2 and the relay roller 20, and brings the leading edge of the print medium into contact with the conveyor roller 2 rotating in the reverse direction. With this, the skew correction for back-side printing is completed. After that, in S11, the MPU 201 restores (decreases) the current upper limit value to the previous value and again switches the rotation direction of the conveyor roller 2 to the forward direction. The MPU 201 cancels the interruption of the ejection driving of the print head 4 in S12, and finishes measuring the ejection interruption time in S13.

In S14, the MPU 201 determines whether the ink ejection interruption time is equal to or greater than a threshold. If the ejection interruption time is equal to or greater than the threshold (S14: Yes), the MPU 201 advances to S15 to execute preliminary ejection 1. The preliminary ejection herein refers to an operation in which ink, which will not contribute to printing, is ejected from the ejection orifices, and the preliminary ejection 1 is processing which is to be executed if the ejection interruption time is long, and which is expected to recover the print head 4 sufficiently. If the ejection interruption time is shorter than the threshold in S14 (S14: No), the MPU 201 advances to S16 directly. In S16, the MPU 201 rotates the conveyor roller 2 in the forward direction (arrow α direction in FIG. 4A) and performs registration such that the head of an image to be printed on the print medium can be printed by the print head 4. In S17, the MPU 201 executes preliminary ejection 2 and ends the pre-processing for back-side printing. The preliminary ejection 2 is ejection to be performed before the start of printing, and is processing intended to refresh the ink inside the ejection orifices.

After that, the MPU 201 alternately performs a print scanning operation in which the print head driver 208 causes the print head 4 to perform an ejection operation while the carriage motor 204 is driven to move the carriage 5 in the main scanning direction, and a conveyance operation in which the conveyor motor 205 is driven to cause the conveyor roller 2 to convey the print medium by a predetermined distance. Through these operations, the image is printed sequentially on the back side of the print medium.

A reason why the motors are stopped before the current upper limit value is switched in S09 is to keep the power consumptions of the other power consumption units low during the operation of the conveyor motor 205 with its current upper limit value increased. In addition, there is another reason, and this is because the operation of switching the current upper limit value for the motor driver 209 cannot be performed unless all the coupled motors are stopped. In order to keep the power consumptions low during the skew correction, to stop all the motors other than the conveyor motor is not an essential requirement, and parallel operations may be allowed on the premise that the total power consumption is kept low. However, to stop all the motors is an essential requirement for S09 of switching the current upper limit value.

In the present embodiment, in S14, whether to perform the preliminary ejection 1 is determined depending on whether the ejection interruption time is equal to or greater than the threshold. Instead, the MPU 201 may advance to S15 without making the determination in S14 and executes the preliminary ejection 1.

Regarding the current upper limit value, the two levels including the current upper limit value A and the current upper limit value B are set in the above description, but instead, three or more levels may be set. In the case where three or more levels of current upper limit values are set, the following processing may be performed: checking whether the skew correction after the current upper limit value of the conveyor motor 205 is increased once achieves appropriate skew correction; and if not, further increasing the current upper limit value.

In the present embodiment, as described above, in the configuration in which a certain power consumption unit locally consumes the power for a specific operation, the control is performed which temporarily increases the current upper limit value to be involved in the specific operation while saving the power consumptions of the other power consumption units not to be involved in the specific operation. This enables the entire apparatus to keep the peak power low and limit the power consumption within the appropriate range. As a result, there is no need to install a capacitor with an excessively large capacity and the like, which makes it possible to achieve cost reduction, apparatus downsizing, and better environmental compatibility.

In the present embodiment, the single motor driver is provided for the motors and uses a common set value as the current upper limit value, but an embodiment is not limited to this. An independent motor driver may be provided for each motor, have an independent set value, and individually switch the current upper limit value. The liquid ejection apparatus 50 has a first mode of controlling the motor and the power consumption units while the upper limit value of the current suppliable to the motor is set to a first upper limit value. In addition, the liquid ejection apparatus 50 has a second mode of controlling the motor and the power consumption units while the upper limit value of the current suppliable to the motor is set to a second upper limit value that is greater than the first upper limit value and the power consumptions of the other power consumption units are kept lower than in the first mode. The liquid ejection apparatus 50 is capable of shifting between the first mode and the second mode.

In this way, the liquid ejection apparatus 50 performs the control to switch the current upper limit value for the conveyor motor 205 while restricting the operations of the other power consumption units. This makes it possible to provide a liquid ejection apparatus and a liquid ejection apparatus control method that enable power consumption saving, apparatus downsizing, and cost reduction.

### Other Embodiment

Hereinafter, another embodiment of the present disclosure will be described in reference to the drawings. Since the basic structure of the present embodiment is the same as that of the aforementioned embodiment, only a characteristic structure will be described below.

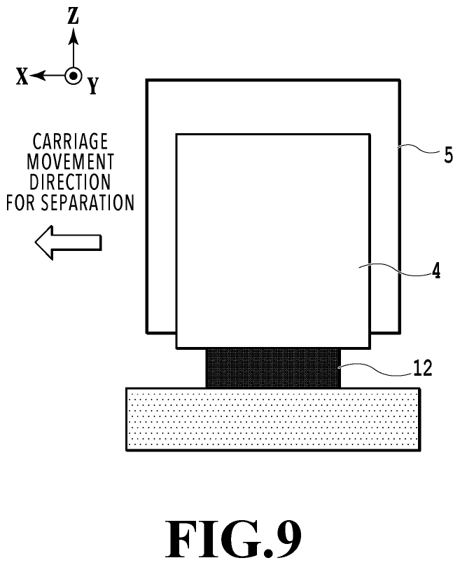

FIG. 9 is a diagram illustrating a print head 4 and a cap 12 in a liquid ejection apparatus 50. In the first embodiment, the configuration to locally increase the power for performing the skew correction for the back-side printing is described as an example. For this reason, the control to switch the current upper limit value is applied to the operation of performing the skew correction of the print medium during the conveyance for the back-side printing. In the present embodiment, a configuration to locally increase the power for uncapping the recovery unit will be described as an example. For this reason, the control to switch the current upper limit value is applied to an operation of uncapping the recovery unit.

FIG. 9 illustrates a state where the cap 12 as a protective member is in contact with an ejection orifice surface (ejection section) of the print head 4. In a case where the print head 4 is left without performing the ejection operation for a predetermined period of time or longer, the ejection orifice surface of the print head 4 is protected by the cap 12, as illustrated in FIG. 9, in order to hinder the ink from vaporizing. However, if this capping state is maintained for a long period of time with the ink present in between, the cap 12 may stick to the print head 4 and a large force may be used to separate the two for the next printing operation. In the present embodiment, the carriage motor 204 raises and lowers the cap 12 to and from the ejection orifice surface of the print head 4.

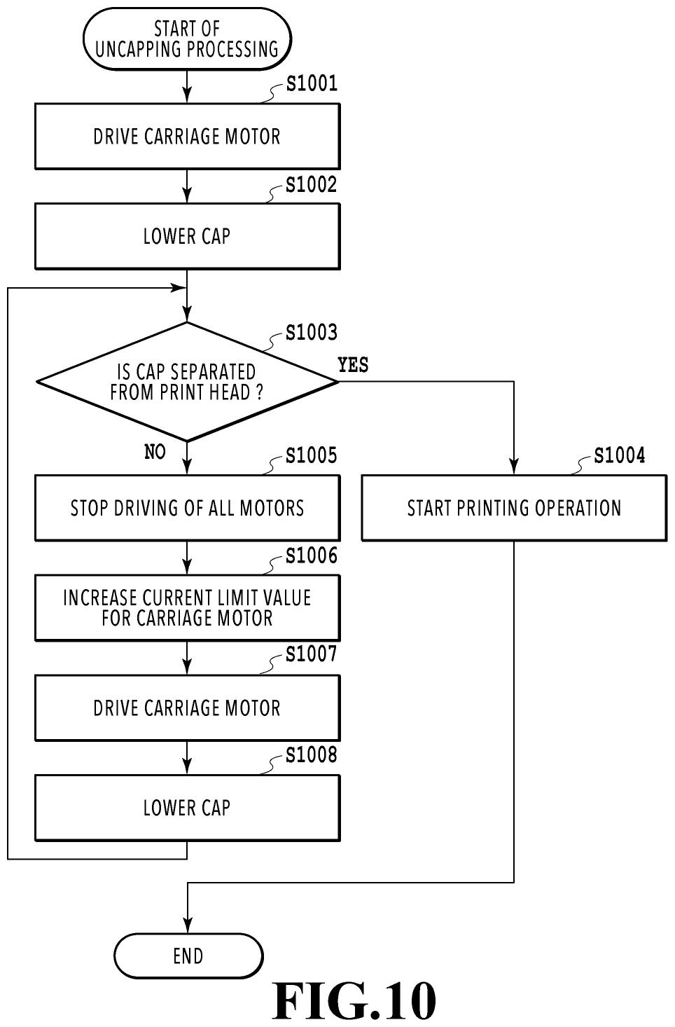

FIG. 10 is a flowchart presenting uncapping processing in the present embodiment. This processing is started at a time point at which a job for printing an image is inputted in a state the print head 4 is capped. Hereinafter, the uncapping processing in the present embodiment will be described by using the flowchart of FIG. 10. A series of processes presented in FIG. 10 is performed by the MPU 201 in the liquid ejection apparatus 50 loading program codes stored in the ROM 202 into the RAM 203 and executing the loaded program codes. Instead, some or all of functions in steps of FIG. 10 may be implemented by hardware such as an ASIC or electronic circuit. In description of each process, sign “S” indicates a step in this flowchart.

Upon input of a job for printing an image in the state where the print head 4 is capped, the MPU 201 drives the carriage motor 204 in S1001 and lowers the cap 12 in contact with the print head 4 in S1002. In S1003, the MPU 201 determines whether the cap 12 is separated from the print head 4. If the cap 12 is separated (S1003: Yes), the MPU 201 advances to S1004 to start the printing operation, and ends the processing. If the cap 12 is not separated from the print head 4 in S1003 (S1003: No), the MPU 201 advances to S1005 and stops the driving of all the motors. In S1006, the MPU 201 increases the current upper limit value for the carriage motor 204. The MPU 201 drives the carriage motor 204 in S1007 and lowers the cap 12 in S1008. After that, the MPU 201 returns to S1003 and iterates the processes. Here, the motors other than the carriage motor 204 may be prohibited from being driven, but may be allowed to operate with their power consumptions kept low after the current upper limit value is changed.

In addition, in the case where the processing is returned from S1008 to S1003, the current upper limit value for the carriage motor 204 is increased in S1006. In this step, in a case where three or more levels of current upper limit values are set, the current upper limit value may be changed to increase stepwise. In a case where two levels of current upper limit values are set, if the current upper limit value is already once changed to increase, the carriage motor 204 may be driven again to perform the operation of lowering the cap 12 while the currently-set current upper limit value is kept unchanged.

This makes it possible to avoid an operation failure in a product equipped with a power source with a small capacity after the product is left unused for a long period of time.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-089183, filed May 31, 2024, which is hereby incorporated by reference herein in its entirety.

What is claimed is:

1. A liquid ejection apparatus comprising:
a print unit configured to perform printing on a print medium conveyed;
a motor in which a current value varies depending on a load;
a power consumption unit different from the motor;
a power source capable of supplying power to the motor and the power consumption unit; and
a controller unit configured to control the motor and the power consumption unit, wherein
the controller unit is capable of shifting between
a first mode of controlling the motor and the power consumption unit in a state where an upper limit value of a current suppliable to the motor is set to a first upper limit value, and
a second mode of controlling the motor and the power consumption unit in a state where the upper limit value of the current suppliable to the motor is set to a second upper limit value that is greater than the first upper limit value and a power consumption of the power consumption unit is kept lower than in the first mode.

2. The liquid ejection apparatus according to claim 1, wherein the motor is a first motor capable of driving a conveyor unit configured to convey a print medium onto which a liquid is to be applied by an ejection unit.

3. The liquid ejection apparatus according to claim 2, wherein the power consumption unit includes the ejection unit and a second motor that is different from the first motor and that is configured to move the ejection unit.

4. The liquid ejection apparatus according to claim 2, wherein the power consumption unit includes a third motor that is different from the first motor and that is capable of driving a document reader unit.

5. The liquid ejection apparatus according to claim 2, wherein
the liquid ejection apparatus is capable of reversing the print medium after the liquid is ejected onto a front side of the print medium, and further ejecting the liquid onto a back side of the print medium, and
the controller unit shifts from the first mode to the second mode in preparation for an operation in which the conveyor unit corrects a skew of the print medium before the ejection unit ejects the liquid onto the back side.

6. The liquid ejection apparatus according to claim 5, wherein
the conveyor unit includes a conveyor roller configured to nip a print medium during ejection of the ejection unit, and a relay roller configured to reverse and convey the print medium, and
the skew is corrected with the relay roller bringing a leading edge of the print medium into contact with the conveyor roller.

7. The liquid ejection apparatus according to claim 5, wherein
after the skew of the print medium is corrected, the controller unit shifts from the second mode to the first mode and causes the ejection unit to execute preliminary ejection.

8. The liquid ejection apparatus according to claim 7, wherein
in a case where a period of time for which the ejection unit is stopped exceeds a threshold, the ejection unit is caused to execute the preliminary ejection.

9. The liquid ejection apparatus according to claim 1, wherein the motor is an alternating current (AC) motor or a direct current (DC) motor.

10. The liquid ejection apparatus according to claim 1, wherein the controller unit stops an operation of the power consumption unit in the second mode.

11. The liquid ejection apparatus according to claim 10, wherein, in the second mode, the controller unit stops the operation of the power consumption unit before the second upper limit value is set.

12. The liquid ejection apparatus according to claim 1, wherein the controller unit stops an operation of the power consumption unit in the second mode.

13. The liquid ejection apparatus according to claim 1, wherein, in the second mode, the controller unit operates the power consumption unit so that a power consumption of the power consumption unit is kept lower than in the first mode.

14. The liquid ejection apparatus according to claim 1, wherein
the power consumption unit includes a lifting unit configured to raise and lower a protective member configured to protest an ejection section of the ejection unit, and
the controller unit shifts from the first mode to the second mode in preparation for an operation in which the lifting unit separates the protective member from the ejection section.

15. A liquid ejection apparatus control method for a liquid ejection apparatus including:
a print unit configured to perform printing on a print medium conveyed;
a first motor configured to operate a conveyor unit configured to convey a print medium onto which a liquid is to be applied by an ejection unit, a current value of the first motor varying depending on a load;
a second motor that is different from the first motor and that is configured to operate a predetermined mechanism different from the conveyor unit; and
a power source capable of supplying power to the ejection unit, the first motor, and the second motor,
the method comprising:
a first step of operating the conveyor unit and the predetermined mechanism in a state where an upper limit value of a current suppliable to the first motor is set to a first upper limit value; and
a second step of operating the conveyor unit and the predetermined mechanism in a state where the upper limit value of the current suppliable to the first motor is set to a second upper limit value that is greater than the first upper limit value, and a power consumption of the predetermined mechanism is kept lower than in the first step.
